(19) United States
(12) Patent Application Publication
(10) Pub. No.: US 2006/0234000 A1
(43) Pub. Date: Oct. 19, 2006

(54) Recordable optical record carrier for multilevel and method for writing thereon

(75) Inventors: Erwin Rinaldo Meinders, Eindhoven (NL); Andrei Mijiritskii, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics, N.V., Eindhoven (NL)

(21) Appl. No.: 10/567,839

(22) PCT Filed: Aug. 12, 2004
(86) PCT No.: PCT/IB04/51451

§ 371 Date: Feb. 8, 2006

(30) Foreign Application Priority Data
Aug. 13, 2003 (EP) 03102528.1
Dec. 3, 2003 (EP) 03104508.1

(51) Int. Cl. B32B 3/02

(52) U.S. Cl. 428/64.4

(57) ABSTRACT

A recordable optical record carrier is provided comprising a recording dye layer, whereby said recording dye layer (111) comprises at least two organic dye materials being absorptive at different wavelengths. Further, a method for writing on such a recordable optical record carrier is proposed. According to the method marks representing the data are written via a writing laser beam at a first predetermined wavelength according to a writing strategy providing a channel bit length and a mark width appropriate for read-out by a beam of electromagnetic radiation at a second predetermined wavelength being different from said first predetermined wavelength.

The present invention relates to a recordable optical record carrier, and in particular to a write once read many (WORM) disc, comprising a recording dye layer. It further relates to a method for writing information on such a recordable optical record carrier.

WORM discs such as CD-R or DVD+R as well as re-writable discs have seen an evolutionary increase in data capacity by increasing the numerical aperture of the objective lens and a reduction of the laser wavelength. The total data capacity was increased from 650 MB (CD, NA=0.45, λ=780 nm) to 4.7 GB (DVD, NA=0.65, λ=670 nm) to finally 25 GB (Blu-ray Disc (BD), NA=0.85, λ=405 nm).

In case of WORM discs dye recording is the writing principal of choice: CD-R discs have been introduced several years ago and DVD+R discs become more and more generally accepted both employing dye recording. Dye recording is also explored as option for BD-R recording. Dye recording type discs are typically composed of a polycarbonate substrate having an organic dye layer applied as recording layer on a first surface. Known dye materials are cyanine, phthalocyanine and metallized azo. A reflective metal layer, typically a gold or silver layer, is attached to a second surface of said recording layer opposite to the substrate. A writing laser beam entering the stack from the substrate side will be partially absorbed by the recording layer, which is heated in that way. Thereby, the dye pigments durably and irreversibly change their color and structure, i.e. the recording layer is locally bleached and decomposed. Also, some mechanical deformation of the recording stack may occur. A reading beam striking a mark written in that manner will be partially scattered by the bleached area Consequently, the intensity of the light reflected at said reflective metal layer depends on whether the reading beam strikes a mark or passes the recording layer almost undisturbed.

However, the above standards are not throughout compatible so that for example a BD disc can be used in an appropriate BD recorder, only. When, BD recorders will be introduced in the market it will be advantageous that a single type of write-once discs can be recorded in both the known DVD recorders and the new BD recorders. In addition, the compatibility should not be sacrificed, i.e. when a disc is recorded in blue, it should be readable in red and vice versa Hence, there will be a general demand for discs that are recordable and/or readable at two or more wavelengths. Further, there is no compatibility between marks written at different wavelengths in such a way that a disc or section of a disc recorded at one wavelength (e.g. blue ray) can be read-out at another wavelength (e.g. red light) and vice versa

Therefore, it is an objective of the present invention to provide a recordable optical record carrier which meets the upcoming demand. It is another objective of the present invention to provide a method for writing information on such a record carrier in a compatible manner.

According to a first aspect of the invention this objective is achieved by a recordable optical record carrier comprising a recording dye layer, whereby said recording dye layer comprises at least two organic dye materials being absorptive at different wavelengths.

A recording dye is typically characterized by wavelength dependent optical properties such as index of refraction and absorption and possesses a sharp absorption peak around the wavelength of operation. For CD-R, DVD+R and BD-R, these absorption peaks are around 780, 670, and 405 nm, respectively. The proposed recordable optical record carrier, however, allows for recording at two or even more wavelengths, whereby only one of the dye materials is responsible for the change in the optical properties of the recording layer. When a writing laser beam is applied to such a record carrier or disc only that dye material is causing the local bleaching and decomposing of the entire recording layer which has an absorption function appropriate for the specific wavelength of the beam. It is noted that the bleaching and decomposition of dye is a temperature-induced process. This means that in case of a mixture of two or more recording dyes, one of the dyes will absorb the laser light that corresponds to the absorption characteristics of that dye, thereby causing a local temperature rise of the entire recording layer. So, although only one of the dye components is responsible for laser light absorption, all dyes mixed in the recording layer will decompose and bleach.

For example, in a DVD-BD combination, two dye materials are combined such that both at 670 nm and at 405 nm wavelength a degradation of one of the dye materials may be induced by laser light absorption. Each absorption is sufficient for an overall change of the optical properties of the recording layer at the location where the laser beam hits the recording layer. In that way a mark is written so as to ensure a successful readout operation.

The recordable optical record carrier according to the present invention therefore is also referred to as multilevel recordable disc.

According to a second aspect of the invention which constitutes a further development of the first aspect the at least two organic dye materials are mixed within one layer thereby providing a compound material with at least two absorption flanks.

According to a third aspect of the invention which constitutes a further development of the first aspect the recording dye layer comprises at least two recording sub-layers each comprising one of said at least two organic dye materials, respectively.

Possible dyes for use in accordance with both the second and third aspect are phthalocyanines, cyanines, metallic AZO, etc. Further, special dye combinations may be developed that provide two absorption flanks at appropriate wavelengths. An important insight is that one of the components is responsible for the laser-heating-induced decomposition and bleaching but that bleaching occurs for the entire recording layer. In both cases, recording sub layers and single recording layer with mixed dye materials, the dye material not being absorptive for the applied laser light is indirectly heated, thereby being decomposed.

According to a fourth aspect of the invention which constitutes a further development of anyone of the first to third aspects a pre-groove is provided for tracking purposes comprising at least two sub-grooves having different widths.

Pre-grooves as for example standardized in ECMA-279 for DVD-R are applied before the recording of any information and used to define the track location. The recording of data according to these standards is made in the center of the groove. Therefore, different servo signals, such as a radial push-pull tracking error signal, are derived from the light reflected at the pre-groove during reading and/or writing of the disc using a quadrant photo detector. However, laser beams with different wave lengths have different optical resolutions. Therefore, the pre-groove according to the fourth aspect of the present invention comprises multiple (at least two), for example staircase shaped concentric, sub-grooves having different appropriate widths in order to ensure that a tracking signal can be derived at various reading/writing wavelengths. A record carrier applying sub-grooves has the advantage that marks can be written at either wavelength independent of the location on the track. The data capacity of such a disc, however, is limited to the lowest of the two combined standards, e.g. about 4.7 GB for a DVD-BD combination, since the data capacity is determined by the track pitch and the channel bit length, both imposed by the longest wavelength system (DVD in this case).

According to a fifth aspect of the invention which constitutes a further development of anyone of the first to third aspects a pre-groove is provided for tracking purposes comprising at least two consecutive sections each having different widths.

By this means the disc can be split into, e.g. radial, segments. In that case, the sub-grooves are not necessary and the groove shape of each segment can be optimized for the respective color. Hence, in each of these segments marks can be written at the appropriate wavelength resulting in data of different data density. For example, the inner part of the disc at small radii can be used for recording with red light while the outer part at larger radii can be used for blue light recording. In such a segmented disc, the area reserved for blue recording can have a reduced track pitch (radial distance between two adjacent tracks determining the radial data density), for example 320 nm according to the BD specifications, while the area reserved for red recording remains at a track pitch of 740 nm according to the DVD specifications. Also the channel bit length determining the tangential data density can be chosen according to the Blu-ray Disc specifications (channel bit length CBL=74.5 nm for BD system, while it is about CBL=175 nm for DVD). Both the partial track pitch and channel bit length reduction in such a segmented disc lead to an enlarged data capacity compared to the sub-groove solution. However, writing in red and in blue is only possible on the assigned segment.

According to a sixth aspect of the invention which constitutes a further development of the fifth aspect at least one of said at least two consecutive sections comprises at least two sub-grooves having different widths.

By this means, a combination of the segmented disc with a sub-groove structure can be achieved. For example, a first segment(s) may be reserved for red light recording, only, comprising a pre-groove structure according to DVD conditions (TP=740 nm, CBL=175 nm), a second segment(s) may be reserved for blue light recording, only, comprising a pre-groove according to BD conditions (TP=320 nm, CBL=74.5 nm), and a third segment(s) may be readable/recordable with blue and/or red light by providing sub-grooves as described above. Hence, in each of these segments marks can be written at the appropriate wavelength resulting in data of different data density. For example, the inner part of the disc at small radii can be used for recording with red light while the outer part at larger radii can be used for blue light recording. In such a segmented disc, the area reserved for blue recording can have a reduced track pitch (radial distance between two adjacent tracks determining the radial data density) for example 320 nm according to the BD specifications, while the area reserved for red recording remains at a track pitch of 740 nm according to the DVD specifications. Also the channel bit length determining the tangential data density can be chosen according to the Blu-ray Disc specifications (channel bit length, CBL=74.5 nm for BD system, while it is about CBL=175 nm for DVD). Writing in the separate red and blue segments in accordance with the DVD and BD specifications, respectively, therefore will result in a data capacity in between 4.7 and 25 GB. The total data capacity of such a multi-color disc will depend on the ratio of red and blue segments. Both the partial track pitch and channel bit length reduction in such a segmented disc leads to an enlarged data capacity compared to the sub-groove disc. However, writing in red and in blue is only possible on the assigned segment

According to a seventh aspect of the invention the objective is achieved by a method for writing data on a segment of a multi-color recordable disc, wherein marks representing the data are written via a writing laser beam at a first predetermined wavelength according to a writing strategy providing a channel bit length and a mark width appropriate for read-out by a beam of electromagnetic radiation at a second predetermined wavelength being different from said first predetermined wavelength.

According to an eighth aspect which constitutes a further development of the seventh aspect of the invention said first predetermined wavelength is shorter than said second predetermined wavelength and said writing strategy utilizes a pulsed laser beam applying an increased number of laser pulses compared to the number of laser pulses appropriate for writing marks at said first predetermined wavelength.

According to a ninth aspect which constitutes a further development of the seventh or eighth aspect of the invention said first predetermined wavelength is shorter than said second predetermined wavelength and said writing strategy utilizes a pulsed laser beam applying beam pulses with extended pulse duration compared to the pulse duration appropriate for writing marks at said first predetermined wavelength.

According to a tenth aspect which constitutes a further development of anyone of the seventh to ninth aspects of the invention said first predetermined wavelength is shorter than said second predetermined wavelength and said writing strategy utilizes a pulsed laser beam applying laser beam pulses of increased laser power compared to the laser power for writing marks at said first predetermined wavelength.

According to an eleventh aspect which constitutes a further development of the tenth aspect of the invention said pulsed laser beam is defocused with respect to an addressed recording layer of said multi-color recordable disc.

According to a twelfth aspect which constitutes a further development of the seventh aspect of the invention said first predetermined wavelength is longer than said second predetermined wavelength and said writing strategy utilizes a pulsed laser beam applying a decreased number of laser pulses compared to the number of laser pulses appropriate for writing marks at said first predetermined wavelength.

According to a thirteenth aspect which constitutes a further development of anyone of the seventh to twelfth aspects of the invention said first predetermined wavelength is longer than said second predetermined wavelength and said writing strategy utilizes a pulsed laser beam applying beam pulses with shorter pulse duration compared to the pulse duration appropriate for writing marks at said first predetermined wavelength and whereby said marks are shrunk after writing.

According to a fourteenth aspect which constitutes a further development of anyone of the seventh, twelfth, or thirteenth aspects of the invention said first predetermined wavelength is longer than said second predetermined wavelength and said writing strategy utilizes a pulsed laser beam applying laser beam pulses of decreased laser power compared to the laser power appropriate for writing marks at said first predetermined wavelength.

According to a fifteenth aspect which constitutes a further development of anyone of the seventh to fourteenth aspects of the invention information representative for said writing strategy is stored in an identification block preceding said segment.

According to a sixteenth aspect which constitutes a further development of anyone of the seventh to fifteenth aspects of the invention information representative for said channel bit length is stored in said identification block preceding said segment.

According to a seventeenth aspect which constitutes a further development of anyone of the seventh to sixteenth aspects of the invention information representative for a reflection level is stored in said identification block preceding said segment.

The groove structure of a multi-color disc allows to write broader and narrower marks (also referred to as pits). The width of the mark depends on the applied write power, pulse duration and size of the write spot (blue or red). The optical spot generated by the laser beam determines the size of the written marks. In order to allow writing data at a certain wavelength on a multilevel recordable disc which are readable at a different wavelength the size of the marks has to be controlled both in length due to a different channel bit length and in width due to a different resolution and track pitch. According to the present invention this is achieved by choosing the writing strategy, including power levels, number of write pulses, pulse lengths and shapes, etc., complying with a channel bit length and a width appropriate for a read-out beam of electromagnetic radiation at a second predetermined wavelength.

In particular, the width of the mark can be controlled for example with a certain pulse shape, such as a multiple pulse strategy, or decreasing block pulse, or a dog-bone pulse, or a defocused beam, all in combination with an appropriate writing power. In a DVD-BD system for example, the disc can be readout at both 670 nm and 405 nm. To allow marks written at longer wavelengths, e.g. in red using DVD-kind of optics, to be read-out at shorter wavelengths, e.g. in blue with BD kind of optics, narrow marks should be written, preferably with a multiple pulse strategy to suppress lateral heat diffusion. Another possibility is to use low write powers or to utilize a write strategy that leads to the phenomenon of “pit shrinking”. The other way round, marks to be written at shorter wavelengths, e.g. in blue (BD), can also be readout at longer wavelengths, e.g. in red (DVD), if a writing strategy is applied providing “overpower” and elongated block pulses or dog bone. By applying overpower lateral heat diffusion is generated producing marks being wide enough to allow readout at longer wavelengths.

The channel bit length can be controlled by the length and the number of the writing pulses, thereby maintaining the condition for a correct mark width. In this way, narrow but long marks that are readable in blue can be written also with DVD kind of optics. Further the channel bit length can be adapted to that of DVD by writing in blue with longer write pulses or a larger number of the write pulses per signal.

This can be accomplished by primarily determining whether a multilevel recordable disc is present, i.e. inserted in the recorder, and retrieving track pitch information. Corresponding information may be provided by the disc itself, for example, stored in the pre-groove in form of a modulation of a wobble signal, in a known in the art manner. Alternatively, the information may be stored as (pre-)recorded data in the lead-in zone or elsewhere on the disc. Such information can be derived by means of a read out device as known from, for example, CD-R/RW or DVD+R/RW recorders.

Writing strategy information, i.e. information on the desired channel bit length, the mark width, the type of segment to be written, write power, pulse length and shape, number of pulses, etc. then can be deduced from a “writing mode” input, e.g. selected by a user, corresponding to a desired resolution. The writing beam will be generated accordingly having predetermined writing power characteristics corresponding to said write strategy information resulting in marks with an appropriate width and length.

The write strategy information then can be stored in the lead-in zone of the disc, at the beginning of each section of the multi-color disc or of a written data block in an identification block. References to data blocks, i.e. the start address and the end address, can be written in the lead-in zone. The lead-in zone may also contain information with respect to the allocation of different segments. For example, a disc may be completely reserved for BD or DVD density.

If the lead-in zone of a multi-color disc indicates whether or not multi-level recording has been applied in specific sections the write strategy information can be used for read-out in a device providing a wavelength different from that of the recorder and if necessary having a different numerical aperture of the optical pick-up unit. Thus, segments of a multi-color disc for example written with a CBL of 74.5 nm can be easily readout in a BD device. Segments of a multi-color disc for example written with a CBL of 175 nm can be easily readout in a DVD drive. Since readout of large bits (CBL=175 nm) with a blue spot will result in different modulation and reflection levels, details with respect to modulation and reflection levels can be included in the identification blocks of the mixed segments.

Readout and interpretation of the lead-in zone and the identification blocks can be enabled by a firmware add-on for the device.

The above an other objectives, features and advantages of the present invention will become apparent from the following description of preferred embodiments thereof taken in conjunction with the accompanying drawings in which

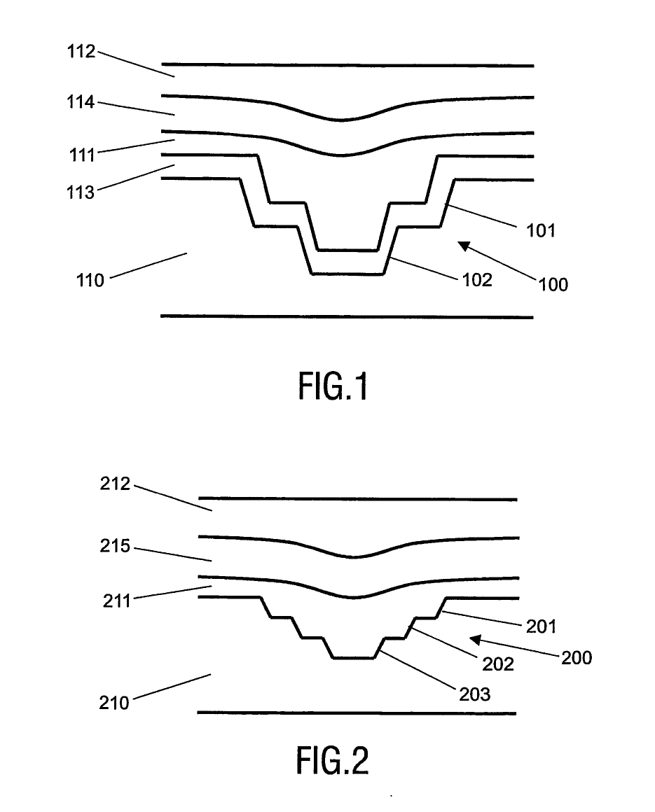

FIG. 1 shows a cross-sectional view of a sub-groove structure in a disc according to a first embodiment of the present invention;

FIG. 2 shows a cross-sectional view of a sub/groove structure in disc according to a second embodiment; and

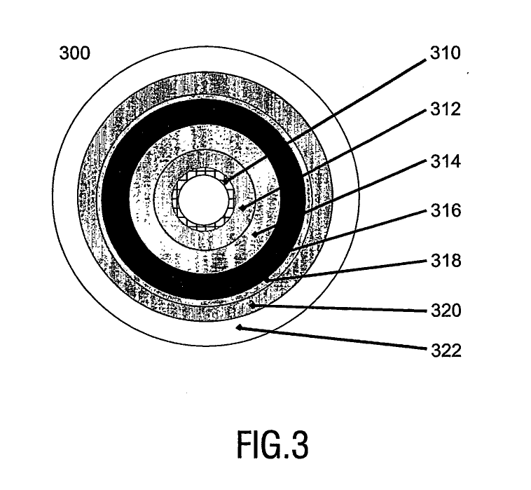

FIG. 3 shows a top view of simplified implementation of a segmented multicolor recordable disc.

A pre-groove 100 in a recordable disc according to the present invention, hereinafter also referred to as multi color or multi level disc, is shown in FIG. 1 in a radial cross sectional view, i.e. perpendicular to the tangential direction of the groove. This pre-groove comprises an outer sub-groove 101 being wider and being used for tracking at a longer wavelength. Further, an inner sub-groove 102 is provided which enables tracking at a shorter wavelength. The depth and width of the outer and inner sub-grooves depend on the wavelength and the optical properties of the disc such as the reflectivity of the recorded and unrecorded state and need to be adapted for optimum tracking.

For example, according to a first embodiment, a mixture of DVD+R and BD-R dyes is spin-coated either directly or with an intermediate layer 113 on top of a DVD substrate 110, one being absorptive in blue (405 nm) an the other in red (670 nm), thereby forming a recording dye layer 111. Alternatively, two separated dye layers, one being absorptive at one wavelength the other being absorptive at the other wavelength, may be deposited on top of each other. The thickness of the dye layer 111 is between 20 nm and 250 nm at the location of the groove 100. By tuning the viscosity of the dye leveling during spin coating and drying can be controlled.

The pre-groove structure 100 is formed within the DVD substrate 110 which is preferably made of polycarbonate, whereby tracks (360° turn of a continuous spiral) of the outer groove 101 are replicated in the DVD substrate 110 at a track pitch of 740 nm. The width of the outer groove 101 is preferably between 200 nm and 400 nm. The depth of the outer groove 101 is preferably between 80 nm and 100 nm which corresponds to a quarter wavelength of red light (λ_red/4) used for DVD in order to provide good servo signals (push-pull tracking error signals) for tracking when reading and/or recording with red light.

The tracks of the inner groove 102 are replicated in the bottom of the outer grooves 101 at the same track pitch of 740 nm. This groove serves for generating a servo signal for tracking during reading and/or recording with blue light. The groove width of the inner groove 101 is preferably between 50 and 200 nm and its depth is about 20 nm to 50 nm in order to obtain good push-pull tracking error signals.

Dielectric layers 113, 114 are possibly provided above and/or below the recording dye layer, thereby forming a recording stack, in order to improve the optical contrast and/or recording performance at high speeds. Light then may be reflected at the stack in response to a light beam incident from the substrate side due to an index of refraction mismatch between the recording dye layer and the dielectric. By this means, the reflection requirements for DVD and DVD-R can be easily met by tuning the thickness of the dielectric layers. Many other recording stacks are possible in order to optimize the optical properties: the above recording layer sandwiched between two dielectric layers, a recording dye layer with only one adjacent dielectric layer or without any dielectric layers may be deposited on a reflective metal layer (not shown in this example), e.g. in a fashion commonly known from CD-R.

Finally the recording dye layer 111, recording stack or the metal layer may be subsequently covered with a cover layer 112 having a thickness of e.g. 100 μm to 0.6 mm.

The combination of a numerical aperture of NA=0.85, blue laser light of 405 nm and the 100 μm cover layer ensures a well defined diffraction-limited laser spot and ensures high quality data at BD recording conditions. However, this high NA and cover layer thickness will cause spherical aberrations in case the red laser beam (670 nm) is used to write data. Therefore, spherical aberration corrections can be implemented by using a LC-cell, a grating, or a switchable lens (e.g. based on electrowetting) or a combi-lens (as known from CD-DVD compatible drives). It is also possible to find a compromise by selecting an intermediate cover layer thickness of about 200 μm. By this means, the BD-spot will be blurred, which may be beneficial for writing larger marks, and the blurring of the red spot will be reduced. Additional spherical aberration correction may be applied in this case, too.

According to a second embodiment of the invention shown in FIG. 2, the principle of multilevel recording is extended to a three-fold compatibility. In this case a groove 200 is provided in a substrate 210 comprising three steps 201, 202, and 203, each having a different width, respectively. By this means, tracking is possible when reading and/or recording with laser beams of three different wavelengths, thereby providing good servo signals (push-pull tracking error signals). Accordingly, a mixture or a stack of three dye materials having different absorption flanks should be provided as recording layer 211. Further, in this example a reflective metal layer 215 is deposited on top of the recording dye layer 211, thereby forming a recording stack. As well, an arrangement such as shown in FIG. 1 having two dielectric layers adjacent to the recording dye layer 211 may instead or additionally be employed adapted to provide best optical performance of the stack. To this end it may be advantageous to further provide for different depths of the sub-grooves 201, 202, and 203. Finally, the reflective layer 215 shown in FIG. 2 is covered with a cover layer 212.

The recording stack having a groove structure according to the above embodiments enables multi-level recording according to the present invention. For example, if a laser beam with small laser power at a shorter wavelength (e.g. 405 nm) is focused on the inner sub-groove, only dye material essentially in the center of the inner sub-groove will be degraded. Hence, small pits are created which generate a moderate modulation (variation of the reflection signal) while being readable only at the shorter wavelength. If reading at longer wavelength is desired a corresponding write strategy information may be inputted initiating a laser beam with high laser power and/or extended write pulses (also at the shorter wavelength) which then is focused on the inner sub-groove. Thereby, also the upper part of the groove will be heated to above the degradation temperature. Broader and deeper pits will result which generate a high modulation while being readable at the shorter and longer wavelengths, as well.

In view of multi-level recording it might be favorable to add a thin protection layer, for example a transparent dielectric layer, between the dye and the polycarbonate to avoid degradation of the polycarbonate and to maximize the contrast difference between partial (only the bottom part) and full degradation (the two modes for two-level recording).

FIG. 3 shows a layout of another embodiment of a segmented multi-color disc 300. It contains a lead-in zone 310, a mixed segment 312 comprising plural sub-grooves as described above, a single groove segment 314 according to DVD-standard, a single groove segment 316 according to BD-standard, a second single groove segment 318 according to DVD-standard, a second mixed segment 320, and a still unwritten portion 322. Each of these segments is preceded by an identification block (not shown in figure). While the mixed segment can alternatively contain CBL=74.5 and CBL=175 nm data blocks the single segments can be written with data blocks predetermined by the width of the groove, only. Therefore an identification block preceding each data block within the mixed data segment has to indicate, for example, the CBL and width of this data block. The CBL=74.5 nm block is preferably written with a blue laser, the 175 mm CBL block can be written with a red or with a blue laser. The lead-in zone contains the start and end addresses of these segments.

Reading and writing in the mixed sections can be done with both the red DVD laser beam and the blue BD laser beam. According to this example the invention facilitates following possibilities
1. Write in red with CBL=175 nm, readout with red optics (DVD standard)
2. Write in red with CBL=175 nm, readout with blue optics
3. Write in red with CBL=74.5 nm, readout with red optics (although hard to achieve)
4. Write in red with CBL=74.5 nm, readout with blue optics
5. Write in blue with CBL=74.5 nm, readout with red optics (although hard to achieve)
6. Write in blue with CBL=74.5 nm, readout with blue optics (BD standard)
7. Write in blue with CBL=175 nm, readout with blue optics
8. Write in blue with CBL=175 nm, readout with red optics

Two levels enable multi-level recording, but more levels are feasible if the power can be accurately controlled. In other words, the invention is not limited to two- or three-fold compatibility but can be extended straight forward to a higher degree of compatibility, if required. A multicolor recordable disc may comprise multiple recording stacks (dielectric, recording dye layer, dielectric, reflective layer etc.) such as described above laminated onto each other. These stacks may be separated by a spacer layer in commonly known fashion. Further, the invention is not limited to dye recording only, but can be applied to phase change recording as well. Although the above embodiments are described in terms of a DVD-BD combination the invention is not limited to this combination.

1. A recordable optical record carrier comprising a recording dye layer (111, 211), whereby said recording dye layer (111, 211) comprises at least two organic dye materials being absorptive at different wavelengths.

2. A record carrier according to claim 1, characterized in that said at least two organic dye materials are mixed within one layer thereby providing a compound material with at least two absorption flanks.

3. A record carrier according to claim 1, characterized in that said recording dye layer comprises at least two recording sub-layers each comprising one of said at least two organic dye materials, respectively.

4. A record carrier according to claim 1, characterized in that a pre-groove is provided for tracking purposes comprising at least two sub-grooves having different widths.

5. A record carrier according to claim 1, characterized in that a pre-groove is provided for tracking purposes comprising at least two consecutive sections each having different widths.

6. A record carrier according to claim 5, characterized in that said at least one of said at least two consecutive sections comprises at least two sub-grooves having different widths.

7. A method for writing data on a segment of a multi-color recordable disc, wherein marks representing the data are written via a writing laser beam at a first predetermined wavelength, whereby said marks are written according to a writing strategy providing a channel bit length and a mark width appropriate for read-out by a beam of electromagnetic radiation at a second predetermined wavelength being different from said first predetermined wavelength.

8. A method according to claim 7, whereby said first predetermined wavelength is shorter than said second predetermined wavelength and said writing strategy utilizes a pulsed laser beam applying an increased number of laser pulses compared to the number of laser pulses appropriate for writing marks at said first predetermined wavelength.

9. A method according to claim 7, whereby said first predetermined wavelength is shorter than said second predetermined wavelength and said writing strategy utilizes a pulsed laser beam applying beam pulses with extended pulse duration compared to the pulse duration appropriate for writing marks at said first predetermined wavelength.

10. A method according to claim 7, whereby said first predetermined wavelength is shorter than said second predetermined wavelength and said writing strategy utilizes a pulsed laser beam applying laser beam pulses of increased laser power compared to the laser power for writing marks at said first predetermined wavelength.

11. A method according to claim 10, whereby said pulsed laser beam is defocused with respect to an addressed recording layer of said multi-color recordable disc.

12. A method according to claim 7, whereby said first predetermined wavelength is longer than said second predetermined wavelength and said writing strategy utilizes a pulsed laser beam applying a decreased number of laser pulses compared to the number of laser pulses appropriate for writing marks at said first predetermined wavelength.

13. A method according to claim 7, whereby said first predetermined wavelength is longer than said second predetermined wavelength and said writing strategy utilizes a pulsed laser beam applying beam pulses with shorter pulse duration compared to the pulse duration appropriate for writing marks at said first predetermined wavelength and whereby said marks are shrunk after writing.

14. A method according to anyone of claims 7, whereby said first predetermined wavelength is longer than said second predetermined wavelength and said writing strategy utilizes a pulsed laser beam applying laser beam pulses of decreased laser power compared to the laser power appropriate for writing marks at said first predetermined wavelength.

15. A method according to claim 7, whereby information representative for said writing strategy is stored in an identification block preceding said segment.

16. A method according to claim 7, whereby information representative for said channel bit length is stored in said identification block preceding said segment.

17. A method according to claim 7, whereby information representative for a reflection level is stored in said identification block preceding said segment.
